(19) United States
(12) Patent Application Publication
(10) Pub. No.: US 2014/0338847 A1
(43) Pub. Date: Nov. 20, 2014

(54) CURTAIN CONTROL ASSEMBLY

(71) Applicant: UNI-SOLEIL ENT. CO., LTD., Tainan City (TW)

(72) Inventor: YU-TING KAO, TAINAN CITY (TW)

(73) Assignee: UNI-SOLEIL ENT. CO., LTD., Tainan City (TW)

(21) Appl. No.: 13/896,484

(22) Filed: May 17, 2013

(51) Int. Cl. E06B 9/68; A47H 5/02

(52) U.S. Cl. CPC E06B 9/68; A47H 5/02
USPC 160/319

(57) ABSTRACT

A curtain control assembly includes a shaft in which a torque rod and a control unit are received. The curtain is wrapped around the shaft. The control unit has a frame from which a tubular portion extends. The tubular portion has a polygonal protrusion. An end support is located in the frame and has a hook which is hooked to the control unit. A bead-chain disk is mounted to the tubular portion. A mount is mounted to a sleeve of the bead-chain disk. A connection member is fixed to the torque rod and a polygonal recess is defined in the connection member. The protrusion is engaged with the recess. A screw extends through the connection member, the tubular portion and is fixed to the end support. The feed-back of torque from the torque rod is shared by the polygonal recess and protrusion to protect the hook from being broken.

### BACKGROUND OF THE INVENTION

1. Fields of the Invention

The present invention relates to a curtain control assembly, and more particularly, to a curtain control assembly which transfers the torque evenly to protect the parts and prolong the life of control assembly.

2. Descriptions of Related Art

The conventional window curtain is installed to keep privacy of people in the room and prevent outside light from directly entering the room. Some of the window curtains perform decoration feature.

As shown in FIGS. 4 and 5, the conventional control assembly 4 of the window curtain or Roman shade is received in the head box of the window curtain and is cooperated with a shaft 5. The control assembly 4 generally comprises a main part 41, an end support 42, a bead-chain disk 43, a torsion spring 44, a cap 45 and a mount 46. The main part 41 has a disk 411 from which a tube 412 extends, and a passage 413 is defined through the tube 412 and the disk 411. The end support 42 extends through the passage 413 and has a hook 421 at one end thereof so as to be hooked to the side panel 51 of the head box. The other end of the end support 42 has a fixing hole 422. The tube 412 is located corresponding to the bead-chain disk 43 and the torsion spring 44, and the cap 45 is mounted to the outside of the bead-chain disk 43. The mount 46 is mounted to the outside of the tube 412. A torque rod 52 is located in the shaft 5 and has a toothed connection disk 521 so as to be connected with the shaft 5. One end of the torque rod 52 is inserted into the end support 42 and a screw 423 extends through the fixing hole 422 to connect the torque rod 52 and the end support 42. The shaft 5 is located outside of the mount 46. When in use, the user operates the bead chain to control the operation of the control assembly 4. When lowering the curtain, the torque rod 52 is released so that the weight of the curtain on the shaft 5 rotates the shaft so that the shaft 5 and the torque rod 52 both rotate to lower the curtain. In the meanwhile, a torque is fed back to the end support 42. If the torque is too large, the hook 421 of the end support 42 may be broken and the functions of the curtain fail.

FIGS. 6 and 7 disclose a curtain control assembly which is disclosed in Australia Patent No. AU 200053651 C, the curtain control assembly comprises a fixed shaft 6 to which multiple springs 61 are mounted and a driving tool 7 is mounted to outside of the fixed shaft 6 and the springs 61. The driving tool 7 has a driving member 71 and a driven member 72, both of which are driven by the fixed shaft 6. A tubular member 8 with the curtain attached thereto is mounted to the driven member 72 and a connection member 81 is located in the tubular member 8. The connection member 81 is located in a tube 82 which is located in the tubular member 8. A torsion spring 83 is mounted to the tube 82. When operation, the driving tool 7 is operated manually, the driving member 71 drives the driven member 72 so as to rotate the tubular member 8 so that the curtain is lowered or lifted. When the curtain is lowered, the torsion spring 83 releases the torque and the weight of the curtain rotates the tubular member 8. The driven member 72 drives the connection member 81 and the tube 82 rotates. Because the tubular member 8 and the tube 82 and the torsion spring 83 are co-rotated, a torque is fed back to the fixed shaft 6. When the torque is too large, the connection portion between the fixed shaft 6 and the connection member 81 may break.

The present invention intends to provide a curtain control assembly which improves the shortcomings mentioned above.

### SUMMARY OF THE INVENTION

The present invention relates to a curtain control assembly and comprises a shaft having a torque rod and a control unit received therein, wherein the torque rod is connected with the control unit. The shaft has the curtain wrapped therearound. The control unit has a frame which has an end face and a tubular portion extends from the end face. A passage communicates with the end face. The tubular portion has a protrusion extending from the distal end thereof and the protrusion has a hole which communicates with the passage. An end support is engaged with the passage of the end face. A threaded hole is defined centrally in the first end of the end support and a hook is connected to the second end of the end support. The hook is hooked to an end plate of the control unit.

A bead-chain disk is mounted to the tubular portion. A sleeve extends from one side of the bead-chain disk and a torsion spring is located in the sleeve and mounted to the tubular portion. A mount is mounted to the sleeve of the bead-chain disk and located in the shaft. A connection member has a connection portion which is fixed to the torque rod. A recess is defined in the connection member and the protrusion is engaged with the recess. A through path is defined through inside of the recess and a screw extends through the through path of the connection member, the hole of the tubular portion and is fixed to the threaded hole of the end support.

Preferably, the end support has at least one stepped portion formed on outside thereof. The passage has a contact face formed therein which is to the at least one stepped portion.

Preferably, the recess is a polygonal recess and the protrusion is a polygonal protrusion.

The primary object of the present invention is to provide a curtain control assembly, wherein the feed-back of torque from the torque rod is shared by the polygonal recess and protrusion to protect the hook from being broken.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the curtain control assembly of the present invention;

FIG. 2 is a perspective view to show the curtain control assembly of the present invention;

FIG. 3 is a cross sectional view of the curtain control assembly of the present invention;

FIG. 4 is a perspective view to show the conventional curtain control assembly;

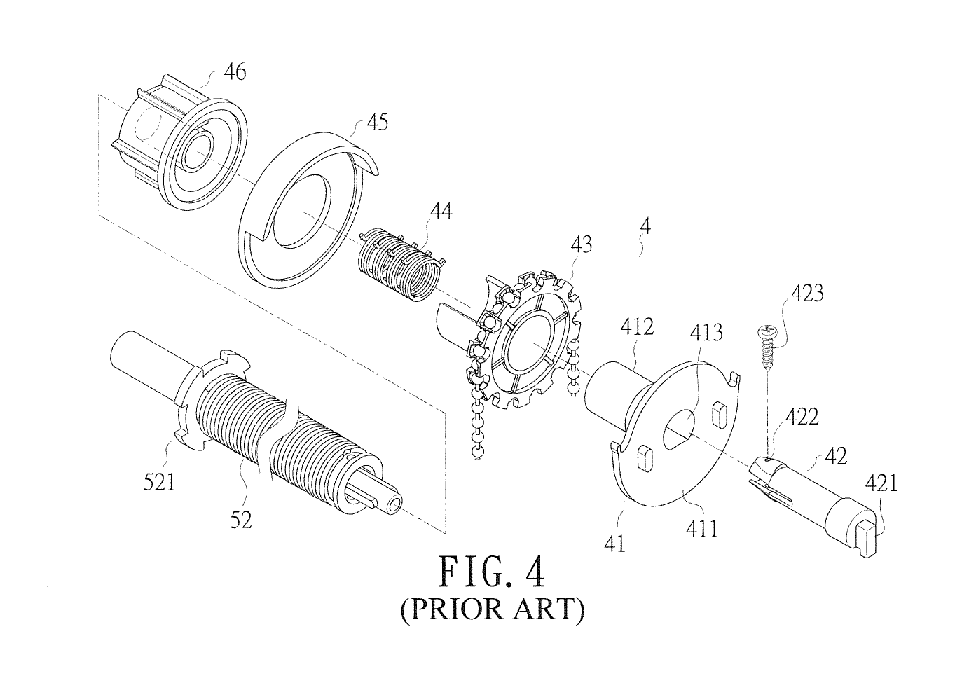

FIG. 5 is a cross sectional view of the conventional curtain control assembly in FIG. 4;

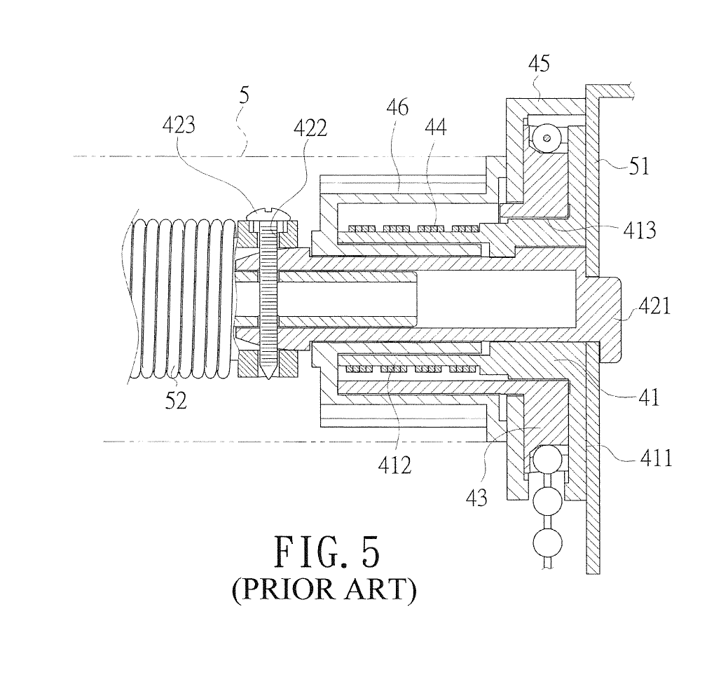

FIG. 6 is a perspective view to show the other conventional curtain control assembly, and

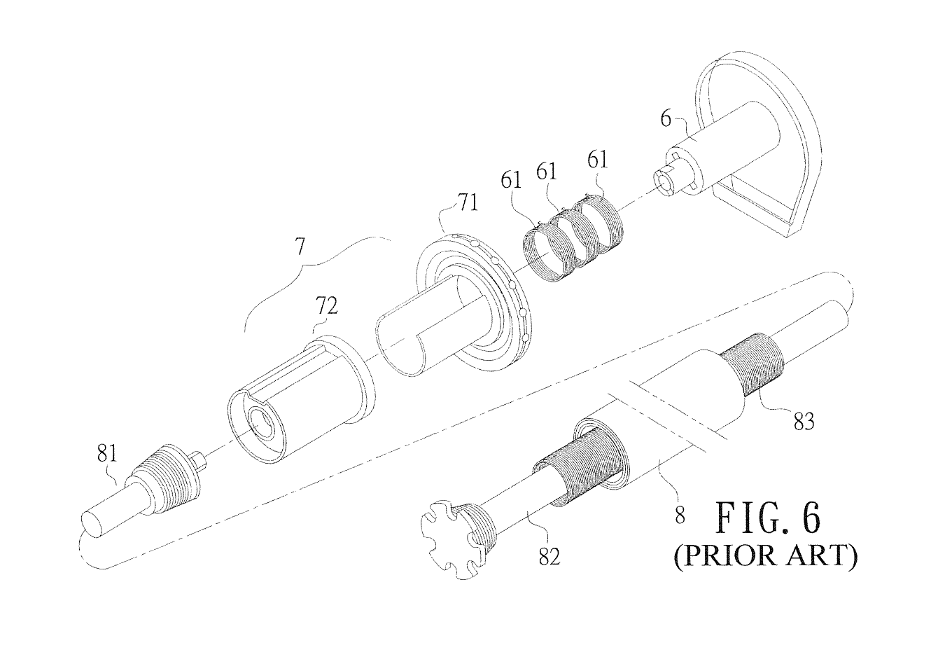

FIG. 7 is a cross sectional view of the conventional curtain control assembly in FIG. 6.

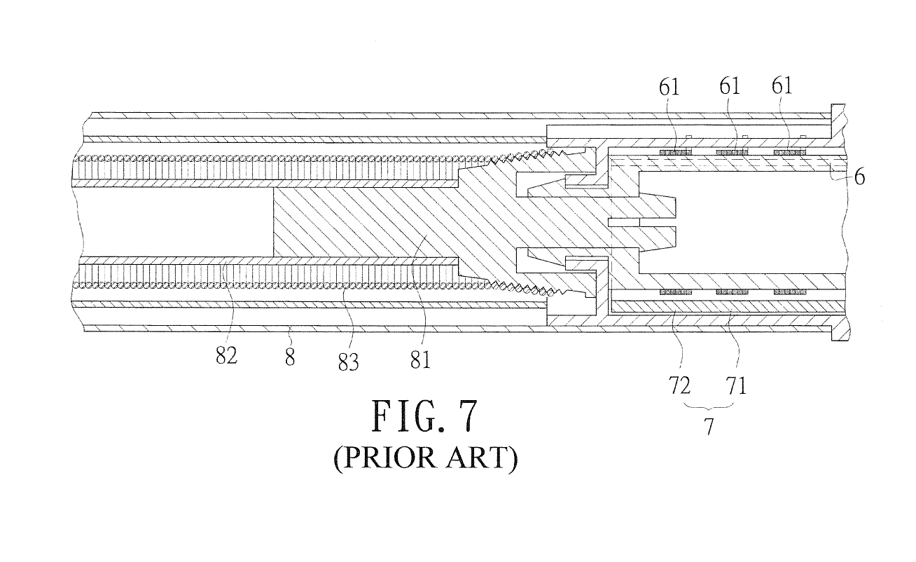

### DETAILED DESCRIPTION OF THE PREFERRED EMBODIMENT

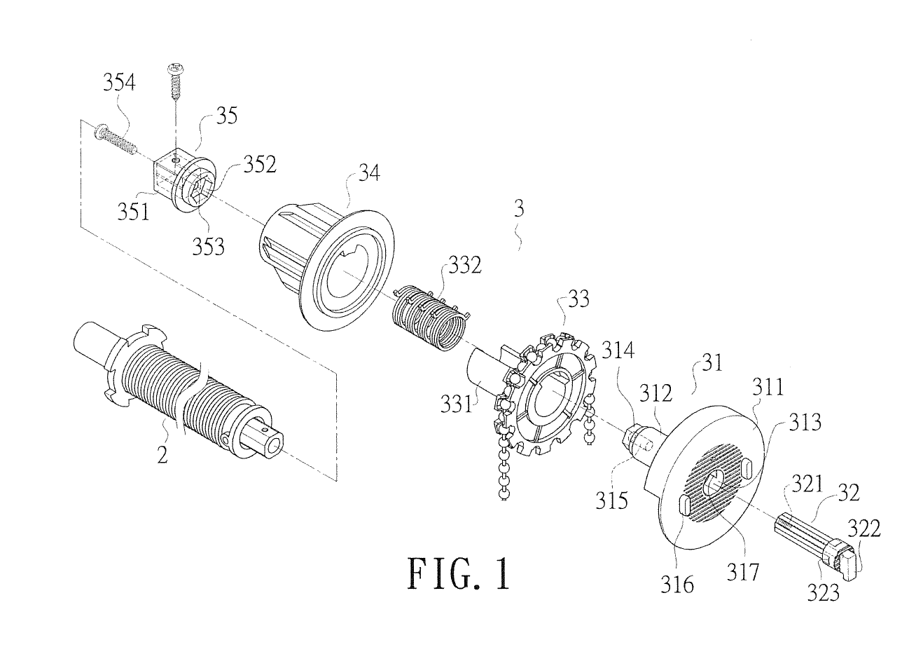

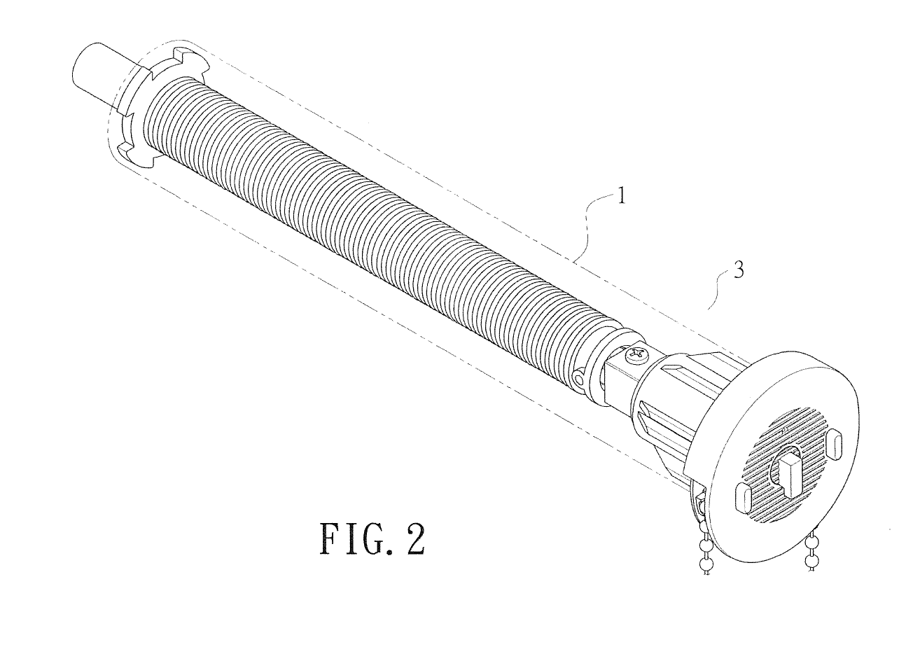

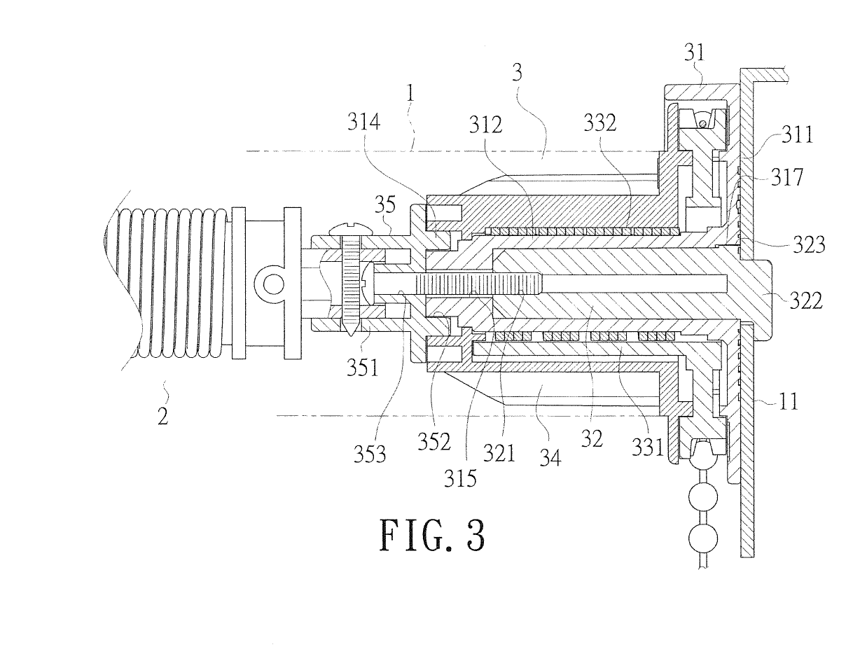

Referring to FIGS. 1 to 3, the curtain control assembly of the present invention comprises a shaft 1 in which a torque rod 2 and a control unit 3 are received. The torque rod 2 is connected with the control unit 3. The curtain is wrapped to the shaft 1.

The control unit 3 comprises a frame 31 which has an end face 311 and a tubular portion 312 extends from the end face 311. The tubular portion 312 has a passage 313 which communicates with the end face 311. The tubular portion 312 has a polygonal protrusion 314 extending from the distal end thereof. The protrusion 314 has a hole 315 which communicates with the passage 313.

An end support 32 is engaged with the passage 313 of the end face 311 and a threaded hole 321 is defined centrally in the first end of the end support 32. A hook 322 is connected to the second end of the end support 32 so as to be hooked to an end plate 11 of the control unit 3.

A bead-chain disk 33 is mounted to the tubular portion 312 and a sleeve 331 extends from one side of the bead-chain disk 33. A torsion spring 332 is located in the sleeve 331 and mounted to the tubular portion 312.

A mount 34 is mounted to the sleeve 331 of the bead-chain disk 33 and located in the shaft 1.

A connection member 35 has a connection portion 351 which is fixed to the torque rod 2. A polygonal recess 352 is defined in the connection member 35 and the protrusion 314 is engaged with the recess 352. A through path 353 is defined through inside of the recess 352 and a screw 354 extends through the through path 353 of the connection member 35, the hole 315 of the tubular portion 312 and is fixed to the threaded hole 321 of the end support 32.

When in assembling, the bead-chain disk 33 is mounted to the tubular portion 312 of the frame 31 and the tubular portion 312 is located in the sleeve 331. The torsion spring 332 is mounted to the tubular portion 312, wherein the two ends of the torsion spring 332 are in contact with the two ends of the sleeve 331. The mount 34 is then mounted to the sleeve 331 of the bead-chain disk 33, and the end support 32 is engaged with the passage 313 of the frame 31. The protrusion 314 of the frame 31 is then engaged with the recess 352 of the connection member 35. The screw 354 then extends through the through path 353 of the connection member 35, the hole 315 of the tubular portion 312 and is fixed to the threaded hole 321 of the end support 32. The connection portion 351 of the connection member 35 is then connected to the torque rod 2. The mount 34 is located in the shaft 1 and the hook 322 of the end support 32 is hooked to the end plate 11 of the control unit 3. The end face 311 of the frame 31 has two bosses 316 which are engaged with the end plate 11 so as to install the control unit 3 in the shaft 1.

When in operation, the user operates the bead-chain disk 33 to drive the control unit 3 to lower or lift the curtain. When lowering the curtain, the weight of the curtain on the shaft 1 and the torque rod 2 releases torques, the shaft 1 is rotated at speed. The shaft 1 and the torque rod 2 are co-rotated, so that the torques from the torque rod 2 is shared by the sides of the recess 352 and the protrusion 314. The end support 32 and the connection member 35 are connected by the screw 354, so that they are not applied by the torques and no torque is not applied to the end support 32 such that the hook 322 is protected from being broken.

The polygonal recess 352 and the polygonal protrusion 314 may have three to six sides. The end support 32 has at least one stepped portion 323 formed on outside thereof, the passage 313 has a contact face 317 formed therein which is located corresponding to the at least one stepped portion 323. By this arrangement, the engagement is more secure and shares the torques.

The advantages of the curtain control assembly of the present invention are that the hook 322 is protected from being broken by the polygonal recess 352 and the protrusion 314. The force to operate the curtain is evenly transmitted so that the life of the parts of the curtain control assembly is prolonged.

While we have shown and described the embodiment in accordance with the present invention, it should be clear to those skilled in the art that further embodiments may be made without departing from the scope of the present invention.

What is claimed is:

1. A curtain control assembly comprising:
a shaft having a torque rod received therein, the torque rod connected with a control unit which is located in the shaft, the shaft adapted to have curtain wrapped therearound, the control unit having a frame which has an end face, a tubular portion extending from the end face and having a passage which communicates with the end face, the tubular portion having a protrusion extending from a distal end thereof, the protrusion having a hole which communicates with the passage;
an end support engaged with the passage of the end face, a threaded hole defined centrally in a first end of the end support and a hook connected to a second end of the end support, the hook hooked to an end plate of the control unit;
a bead-chain disk mounted to the tubular portion, a sleeve extending from one side of the bead-chain disk and a torsion spring located in the sleeve and mounted to the tubular portion;
a mount mounted to the sleeve of the bead-chain disk and located in the shaft, and
a connection member having a connection portion which is fixed to the torque rod, a recess defined in the connection member and the protrusion engaged with the recess, a through path defined through inside of the recess and a screw extending through the through path of the connection member, the hole of the tubular portion and being fixed to the threaded hole of the end support.

2. The curtain control assembly as claimed in claim 1, wherein the end support has at least one stepped portion formed on outside thereof, the passage has a contact face formed therein which is located corresponding to the at least one stepped portion.

3. The curtain control assembly as claimed in claim 1, wherein the recess is a polygonal recess and the protrusion is a polygonal protrusion.

4. The curtain control assembly as claimed in claim 2, wherein the recess is a polygonal recess and the protrusion is a polygonal protrusion.
